(19) United States
(12) Patent Application Publication
(10) Pub. No.: US 2026/0104390 A1
(43) Pub. Date: Apr. 16, 2026

(54) Method and Apparatus for Determining a Wear State of a Roller of a Cam Controller for a Container Treatment Machine

(71) Applicant: Krones AG, Neutraubling (DE)

(72) Inventors: Stefan EIWANGER, Pfatter (DE); Stefan SCHERL, Bernhardswald (DE); Jan TAUBER, Thalmassing (DE)

(21) Appl. No.: 19/355,435

(22) Filed: Oct. 10, 2025

(30) Foreign Application Priority Data
Oct. 14, 2024 (DE) 102024129696.8

(51) Int. Cl. G01N 29/04; G01N 21/892; G01N 27/82

(52) U.S. Cl. CPC G01N 29/041; G01N 21/892; G01N 27/82

(57) ABSTRACT

In a method for determining a wear state of a roller of a cam controller for a container treatment machine, the cam controller includes a control cam, at least one roller movably guided along the control cam, and a measuring element carried along with the roller along the control cam. The control cam comprises a sensor apparatus. The roller is guided past the sensor apparatus as it runs along the control cam, and a distance value between the measuring element and the sensor apparatus is determined using the sensor apparatus as the roller is guided past. A wear state of the roller is determined on the basis of the distance value.

### CROSS-REFERENCE TO RELATED APPLICATIONS

This application claims priority to German Patent Application No. 102024129696.8, filed October 14, 2024, the contents of which are incorporated by reference herein in their entirety.

### TECHNICAL FIELD

The present invention relates to a method for determining a wear state of a roller of a cam controller for a container treatment machine.

### BACKGROUND

Cam controllers for container treatment machines are known from the prior art.

Cam controllers generally comprise a control cam, also called a control track, and at least one roller that can be guided along the control cam. By guiding the roller along the control cam, a component connected to the roller, for example a component of a container treatment machine, can be controlled. For example, based on the shape of the control cam, a time- and position-dependent stroke of the component connected to the roller can be generated. By changing the shape of the control cam, specific stroke patterns can be generated for the component, for example, ones adapted to a process.

Due to the frictional forces that occur when the roller moves along the control cam, the roller may wear out over time. For example, unwanted wear on the running surface of the roller may occur. The wear-induced reduction of the running surface may in turn negatively impact the control cam or the control of the component connected to the roller. For example, the roller may damage the control cam or cause an undesired change in the stroke pattern of the component.

### BRIEF SUMMARY

Embodiments of the present invention provide a method and an apparatus that make possible a continuous monitoring of a wear state of a cam controller.

According to one embodiment of the invention, a method is provided for determining a wear state of a roller of a cam controller for a container treatment machine, wherein the cam controller comprises a control cam, at least one roller movably guided along the control cam, and a measuring element carried along with the roller along the control cam, wherein the control cam comprises a sensor apparatus, wherein the roller is guided past the sensor apparatus as it runs along the control cam, and a distance value between the measuring element and the sensor apparatus is determined by means of the sensor apparatus as the roller is guided past, and a wear state of the roller is determined on the basis of the distance value.

The wear state can set the current condition of the roller in relation to an initial condition of the roller. The initial condition of the roller can, for example, be a new condition of the roller. The wear state can, for example, be expressed as a percentage, wherein a wear state of 0% can mean that the roller is in an initial condition and no wear has occurred. A wear level of 100% can mean that the roller is completely worn out. However, the new condition or the completely worn condition can also be described by any other percentage value or wear state. The expression of the wear state as a percentage is to be understood by way of example; wear can also be defined or determined, for example, by the distance value (as an absolute value or relative value).

The roller can be made of metal and/or plastic. For example, a running surface on which the roller is guided or rotates along the control cam can be made of plastic or comprise plastic. For example, a running surface on which the roller is guided or rotates along the control cam can be made of carbon or comprise carbon. The roller can be movably guided on the control cam by means of a guide device. The guide device can in turn be connected to a component of the container treatment machine that, for example, carries out a treatment step on a container or is involved in carrying out a treatment step on a container. By guiding the roller along the control cam, a movement sequence of the component, such as a deflection of the component from a rest position, can be controlled. The component can be, for example, a component of a labeling machine.

The control cam can be disk-shaped and have any suitable shape and size. For example, it can also be provided that the control cam comprises a disk-like main body and a ring-like profile that is fastened along the circumference of the disk-like main body. The roller can, for example, be guided along the ring-like profile. The shape and size of the control cam can influence the movement of at least one roller when the roller is guided along the control cam. For example, the control cam can comprise a metal and/or a plastic. The control cam can also be manufactured using a generative process.

The measuring element can be a passive measuring element. Passive can be understood to mean that the measuring element does not need to contain any electronics in order to actively carry out a measurement. The measuring element can be understood as a counterpart to the sensor apparatus and, when the roller passes the sensor apparatus, in interaction with the sensor apparatus makes measurement of the distance possible.

The sensor device may be a device designed to measure a distance. The sensor device can, for example, be designed to determine the distance value optically, acoustically or inductively. The types of design of the sensor apparatus just mentioned are to be understood by way of example, so that the sensor apparatus can also determine the distance on the basis of another measuring principle suitable for distance measurement.

The container treatment machine can be, for example, a labeling machine for containers. However, it can also be any other type of container treatment machine, such as a blow-molding machine or a filling machine.

The distance measurement value can, for example, be represented in meters, centimeters, millimeters or any other unit suitable for the (numerical) representation of a distance.

By means of the method according to embodiments of the invention, a distance value between the measuring element and the sensor apparatus can be determined each time the roller passes the sensor apparatus and, on the basis of the distance value, the wear state of the roller can be determined. In this way, continuous monitoring of the wear state of the roller can be achieved and damage to the control cam caused by a worn roller can be prevented.

In one embodiment, it can be provided that the roller for determining the distance value is guided past the sensor apparatus N > 1 times, wherein each time the roller passes the sensor apparatus a distance value between the measuring element and the sensor apparatus is determined, wherein after N passages of the roller past the sensor apparatus a minimum distance value of the N distance values is determined and, on the basis of the minimum distance value, the wear state is determined. N can be a natural number greater than zero. In this way, even in the case of irregular wear of the roller, a sufficiently accurate determination of the wear state can be achieved.

In a further development of the previous embodiment, it can be provided that the minimum distance value after N passages of the roller past the sensor apparatus is determined smoothly, wherein after (N+i) passages of the roller past the sensor apparatus, the minimum distance value of the distance values of the last N passages is determined and, on the basis of the minimum distance value of the last N passages, the wear state is determined. By smoothly determining the minimum distance value, the minimum distance value can also be determined as a function of time.

In one embodiment, it can be provided that the wear state is determined on the basis of a change in the minimum distance value over time. The wear state can thus be continuously determined and a time-dependent wear can be deduced. On the basis of this, wear and tear in the future can also be extrapolated.

In a further development of the preceding embodiment, it can be provided that, if a difference between two successively determined distance values between the measuring element and the sensor apparatus is greater than a threshold value, it is determined that the roller has a defect. In this way, for example, it is possible to determine if part of the running surface has become worn or broken and an immediate replacement of the roller is necessary.

In one embodiment, it can be provided that the measuring element has an essentially cylindrical shape, and a longitudinal axis of the measuring element is aligned parallel to a rotation axis of the roller, or a longitudinal axis of the measuring element coincides with a rotation axis of the roller. An essentially cylindrical shape can be understood to mean that the measuring element either has a cylindrical shape or has a shape that deviates only slightly from the cylindrical shape. The shape that deviates slightly from the cylindrical shape can, for example, be an elliptical shape. Due to the cylindrical shape, an accurate distance measurement between the sensor apparatus and the measuring element can be determined independently of the rotation angle of the roller with respect to a rest position. If the longitudinal axis of the measuring element coincides with the rotation axis of the roller, then the wear state can be directly determined on the basis of the measured distance value, regardless of the rotation angle of the measuring element.

It can further be provided that the sensor apparatus comprises an optical sensor unit, for example a laser, an acoustic sensor unit, for example an ultrasonic sensor, or an inductive sensor unit, wherein if the sensor apparatus comprises the inductive sensor unit, the measuring element will comprise a metal. With appropriate design of the sensor unit, a reliable and precise measurement of the distance value can be achieved.

According to embodiments of the invention, a cam controller for a container treatment machine is also provided, wherein the cam controller comprises a control cam, at least one roller movably guided along the control cam, a measuring element carried along with the roller along the control cam, and a control unit, wherein the control cam comprises a sensor apparatus, wherein the roller is guided past the sensor apparatus as it runs along the control cam, and a distance value between the measuring element and the sensor apparatus can be determined by means of the sensor apparatus as the roller is guided past, wherein the control unit is designed to determine a wear state of the roller on the basis of the distance value.

By means of the control cam according to the invention, a distance value between the measuring element and the sensor apparatus can be determined during each passage and, on the basis of the distance value, the wear state of the roller can be determined. In this way, a continuous monitoring of the wear state of the roller can be achieved and damage to the control cam caused by worn rollers can be prevented.

In one embodiment, it can be provided that the roller for determining the distance value can be guided past the sensor apparatus N > 1 times, wherein each time the roller passes the sensor apparatus a distance value between the measuring element and the sensor apparatus is determined, wherein the control unit is designed to determine a minimum distance value of the N distance values after N passages of the roller past the sensor apparatus, and the control unit is designed to determine the wear state on the basis of the minimum distance value. In this way, even in the case of irregular wear of the roller, a sufficiently accurate determination of the wear state can be achieved.

In a further development of the previous embodiment, it can be provided that the control unit is designed to determine the minimum distance value after N passages of the roller past the sensor apparatus, wherein after (N + i) passages of the roller past the sensor apparatus, the minimum distance value of the distance values of the last N passages is determined, and the control unit is designed to determine the wear state based on the minimum distance value of the last N passages. By smoothly determining the minimum distance value, the minimum distance value can also be determined as a function of time.

Furthermore, it can be provided that the control unit is designed to determine the wear state on the basis of a change in the minimum distance value over time. The wear state can thus be continuously determined and a time-dependent wear can be deduced. On the basis of this, wear in the future can also be extrapolated.

In a further development of the preceding embodiment, it can be provided that the control unit is designed to determine that a defect in the roller is present when a difference between two successively determined distance values between the measuring element and the sensor apparatus is greater than a threshold value. In this way, for example, it is possible to determine if part of the running surface has become worn or broken and an immediate replacement of the roller is necessary.

In one embodiment, it can be provided that the measuring element has an essentially cylindrical shape, and a longitudinal axis of the measuring element is aligned parallel to a rotation axis of the roller or wherein a longitudinal axis of the measuring element coincides with a rotation axis of the roller. Due to the cylindrical shape, an accurate distance measurement between the sensor apparatus and the measuring element can be determined independently of the rotation angle of the roller with respect to a rest position. If the longitudinal axis of the measuring element coincides with the rotation axis of the roller, then the wear state can be directly determined on the basis of the measured distance value, regardless of the rotation angle of the measuring element.

In one embodiment, it can be provided that the sensor apparatus comprises an optical sensor unit, for example a laser, an acoustic sensor unit, for example an ultrasonic sensor, or an inductive sensor unit, wherein if the sensor apparatus comprises the inductive sensor unit, the measuring element will comprise a metal. With a corresponding design of the sensor apparatus, a reliable and precise measurement of the distance value can be achieved.

Furthermore, the sensor apparatus can be fastened to the control cam by means of a holding apparatus, wherein a measuring direction along which the distance value between the sensor apparatus and the measuring element can be determined is perpendicular to an axis of rotation of the measuring element. By arranging the sensor device accordingly, a precise measurement of the distance value can be ensured.

### BRIEF DESCRIPTION OF THE FIGURES

FIG. 1 is a schematic illustration of a cam controller for a container treatment machine according to one embodiment; and

FIG. 2 is a schematic illustration of a cam controller for a container treatment machine according to a further embodiment.

### DETAILED DESCRIPTION

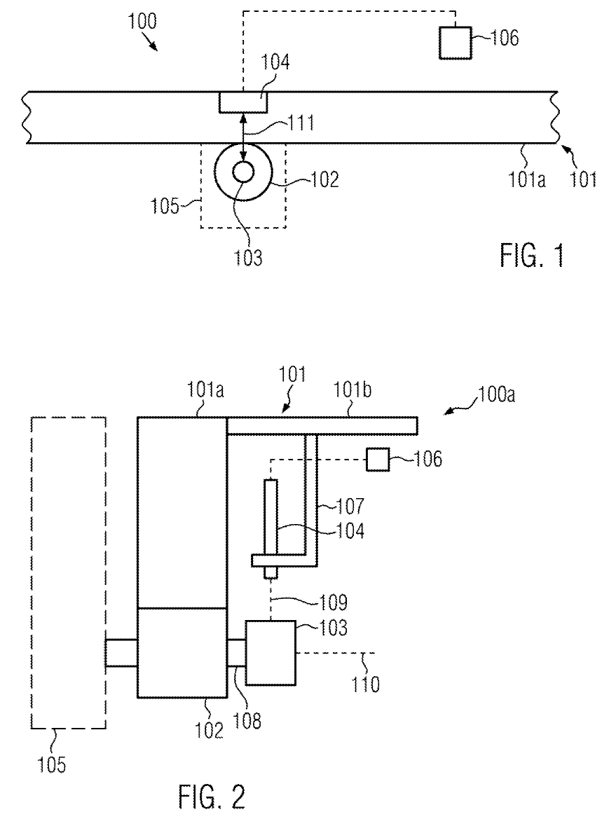

FIG. 1 shows a partial region of a cam controller 100 for a container treatment machine according to one embodiment.

According to an embodiment of the invention, the cam controller 100 comprises a control cam 101, at least one roller 102 movably guided along the control cam 101, a measuring element 103 carried along the control cam 101 with the roller 102, and a control unit 106. The fact that in FIG. 1 only one roller 102 is guided along the control cam 101 is to be understood as an example. More than one roller 102, for example 5, 10, 30 rollers or any other number of rollers can be guided along the control cam 101. The rollers can be guided independently of one another along the control cam 101.

For illustration purposes, only a partial region of the control cam 101 of the cam controller 100 is shown in FIG. 1. In principle, the control cam 101 can be designed as a closed structure along which the at least one roller 102 can be guided along a closed path.

The container treatment machine can be any machine suitable for treating containers, such as a labeling machine. However, it can also be any other container processing machine, such as a blow-molding machine or a filling machine.

According to the invention, the control cam 101 comprises a sensor apparatus 104, wherein the roller 102 can be guided past the sensor apparatus 104 when running along the control cam 101. According to the invention, when the roller 102 is guided past, a distance value 111 between the measuring element 103 and the sensor apparatus 104 can be determined by means of the sensor apparatus 104. Based on the distance value 111, a wear state of the roller 102 can be determined.

The control cam 101 can, for example, comprise a metal and/or a plastic and be designed as a closed track. The control cam can, for example, be manufactured using a generative process. In this way, even complex-shaped control cams 101 can be manufactured in a cost-effective manner.

The control cam 101 can have any shape suitable for controlling a movement sequence of a component of a container treatment unit of a container treatment machine by guiding the roller connected to the component along the control cam 101. The roller can be connected to the component by means of a guide device 105.

The control cam 101 can, for example, be designed as a plate, wherein the roller 102 is guided along a side surface of the control cam 101.

However, it can also be provided that a main body of the control cam 101 is designed as a base plate and a profile is applied to the base plate along the circumference of the base plate along a direction that is perpendicular or essentially perpendicular to a plane spanned by the base plate. Essentially perpendicular can be understood as an angle between 85° and 95° or an angle between 80° and 100°. The roller 102 can be guided along the profile of the control cam 101. It can also be provided that an angle between the plane of the plate and the profile changes along the circumference of the control cam.

Alternatively, it can also be provided that the profile just described is attached to the side of the base plate along its circumference. The variant in which the profile 101a is attached laterally to the base plate along its circumference is shown in FIG. 1, in which the profile 101a of the control cam 101 is shown. In FIG. 1, the roller 102 is thus guided along the profile 101a of the control cam 101.

The base plate of the control cam 101 can, for example, be formed by a closed surface. However, it can also be provided that the base plate comprises a recess. The base plate can be circular, but can also deviate from the circular shape. The deviation from the circular shape can be provided, for example, when the roller 102 is guided along a side surface of the base plate. If the base plate comprises a profile 101a as described above, then it can be provided that a height of the profile 101a changes along the circumference of the control cam 101, so that when the roller 102 is guided along the profile 101a with a variable height, a specific movement sequence of a component of a treatment unit of the container treatment machine connected to the roller 102 can be generated.

The control cam 101 can, for example, be assigned to a rotary machine of the container treatment machine and be provided for controlling a movement sequence of at least one container treatment unit arranged on the rotary machine or a component of a container treatment unit. The control cam 101 can be stationary so that it does not rotate when the rotary machine rotates. If the rotary machine is set in rotation, the roller 102, which is connected to a treatment unit or a component of the treatment unit of the rotary machine via the guide device 105, can be guided along the control cam 101. On the basis of a shape of the control cam 101, or a changing height of the profile 101a of the control cam 101 shown in FIG. 1 along the direction of rotation, different movement patterns of the container treatment unit or the component can be achieved by guiding the roller 102 along the control cam 101. By means of the cam controller 101, a recurring movement sequence of the treatment unit or the component of the treatment unit can thus be achieved mechanically during each revolution of the rotary machine.

For example, the component of the treatment unit can be a labeling component of a labeling machine. The labeling component can be, for example, a holder for containers or a stamping apparatus for applying labels. However, it can also be a blow-molding component of a blow-molding machine, such as a stretch rod. Any other type of treatment unit or component of a treatment unit is also conceivable.

The roller 102 may comprise a metal and/or a plastic. For example, a running surface of the roller 102 can be made of a plastic in order to avoid damage to the control cam 101 when the roller is guided along the profile 101a of the control cam 101. A rim of the roller can, for example, comprise a metal and/or a plastic. Furthermore, it can be provided that the rim includes a ball bearing.

The measuring element 103 may comprise a metal and/or a plastic. A composition of the measuring element can be selected, for example, based on a configuration of the sensor device 104.

The measuring element 103 can be a passive measuring element. Passive can be understood to mean that the measuring element does not have to contain any electronics that are necessary for distance measurement. The measuring element 103 can, for example, be designed as a reflector element from which, for example, radiation or sound waves emitted by the sensor apparatus 104 can be reflected. However, the measuring element 103 does not necessarily have to be passive, but can also comprise electronics that are provided for distance measurement in interaction with the sensor apparatus.

The measuring element 103 can have an essentially cylindrical shape, and a longitudinal axis of the measuring element 103 can be aligned parallel to a rotation axis of the roller 102, or a longitudinal axis of the measuring element 103 can coincide with an axis of rotation of the roller 102. Essentially cylindrical can be understood to mean that the measuring element has a cylindrical shape or has a shape that deviates slightly from the cylindrical shape. A slight deviation can, for example, mean that the circumference of the measuring element is not circular but elliptical.

To achieve the most precise determination of the wear state, it can be provided that the measuring element 103 is designed cylindrically as described above and is arranged with respect to the roller 102 such that its longitudinal axis coincides with an axis of rotation of the roller 102. To achieve this, the measuring element 103 can be connected to the roller 102, for example, via a cheesehead screw not shown here. With a corresponding arrangement of the roller 102 and the measuring element 103, the change in distance measured between the sensor apparatus 104 and the measuring element 103 between at least two passages is attributable solely to wear of the roller 102, for example to wear of its running surface.

If, for example, the measuring element 103 has a shape that deviates from the cylindrical shape, additional corrections of the measured distance values may be necessary, which may depend on a rotation angle of the measuring element 103 as the measuring element 103 moves past the sensor apparatus 104.

The sensor apparatus 104 can be any sensor apparatus suitable for determining a distance value.

For example, the sensor apparatus 104 can be an inductive sensor unit. In this case, it may be provided that the measuring element comprises a metal.

The inductive sensor unit can, for example, comprise a coil and be designed to generate an alternating magnetic field by means of the coil, which in turn induces eddy currents in the metallic measuring element 103. Eddy currents induced in the measuring element act against their cause and thereby influence the impedance of the coil. On the basis of this, the distance between the sensor apparatus 104 and the measuring element 103 can be determined. The configuration of the inductive sensor apparatus just described is to be understood by way of example. The inductive sensor unit can also be designed in another way to determine the distance between the inductive sensor unit and the measuring element.

Alternatively, the sensor apparatus 103 can also be an optical sensor unit, which comprises, for example, a laser. The optical sensor unit can further comprise a detector by means of which a laser pulse, emitted by the optical sensor unit and which is reflected by the measuring element 103 as the measuring element 103 passes the sensor apparatus 104, can be detected. On the basis of the transit time of the laser pulse between emission and detection, the distance value between sensor apparatus 104 and measuring element 103 can be determined. However, the optical sensor unit may also comprise an alternative light source, such as a light source emitting infrared radiation, or any other light source suitable for distance measurement. In the case of an optical sensor apparatus, the measuring element does not necessarily have to comprise a metal in order to determine the distance value. It may nevertheless be provided that the measuring element comprises a metal when using an optical sensor unit.

Furthermore, the sensor apparatus 104 can also be designed as an acoustic sensor unit. For example, the sensor apparatus can comprise an ultrasound source and an ultrasound detector. The ultrasound source can emit ultrasound, which can be reflected by the measuring element 103 as the measuring element 103 passes the sensor apparatus 104 and can be detected by the detector. On the basis of the transit time of the ultrasound between emission and detection, the distance between the sensor apparatus 104 and the measuring element 103 can be determined. That the acoustic sensor apparatus comprises an ultrasound source and an ultrasound detector is to be understood by way of example. The acoustic sensor unit can also be designed to comprise any other type of acoustic source suitable for distance measurement and any other type of acoustic detector. Even in the case of the acoustic sensor unit, the measuring element 103 does not necessarily have to comprise a metal in order to be able to determine the distance between the sensor apparatus and the measuring element. However, it may still be provided that the measuring element 103 comprises a metal.

The design types of the sensor apparatus 104 described above are to be understood by way of example. The sensor apparatus 104 can also be designed in any other way that is suitable for measuring a distance between the sensor apparatus 104 and the measuring element 103.

Optionally, the sensor apparatus 104 can be fastened to the control cam 101 by means of a holding apparatus. This is described in more detail later in connection with FIG. 2.

The sensor apparatus 104 can be fastened to the control cam 101 such that a measuring direction along which the distance value between the sensor apparatus 104 and the measuring element 103 is determined is perpendicular to an axis of rotation of the measuring element 103. In this way, it can be ensured that the measuring element 103, or an axis of rotation of the measuring element 103, is not tilted with respect to the measuring direction. This allows a particularly precise determination of the distance value.

However, it can also be provided that the measuring direction and the axis of rotation are slightly tilted relative to each other. For example, a tilt of 2°, 5° or 10° with respect to the vertical alignment can be provided.

On the basis of the distance value between the measuring element 103 and the sensor apparatus 104 determined by the sensor apparatus 104, the wear state of the roller 102 can be determined.

Optionally, before putting the cam controller 101 into operation, it can be provided that an initial distance value between the sensor apparatus 104 and the measuring element 103 is determined during an initialization process. A specific wear state of the roller 102 can be assigned to this initial distance value.

If, for example, the roller 102 is new, the initial distance value can be assigned a wear state of 0%, which corresponds to the wear state of a new roller that does not yet show any signs of wear. However, any other wear state can also be assigned to the new roller 102. If the roller 102 is not a new roller but rather a roller that already shows signs of wear, a different wear state can also be assigned to the initial distance value. Optionally, it can, for example, also be provided that the sensor apparatus 104 comprises a detection device that can classify the roller used, so that an initial wear state can be assigned to the initial distance value on the basis of the roller type.

The control unit described above can be provided to determine the wear state on the basis of the distance value. The control unit may comprise a processor and a memory unit (e.g. a non-volatile memory). In the memory unit, a corresponding wear state can be assigned to the initial distance value.

Because each time the roller 102 passes the sensor apparatus 104 only that distance value between the sensor apparatus 104 and the measuring element 103 is determined which is defined by the radius of a surface element of the running surface of the roller 102 that is in contact with the control cam during the distance measurement and thus at least indirectly sets the distance value between the measuring element and the sensor apparatus, a reliable wear state can be determined from a single distance measurement only for a roller that is worn uniformly (along the entire circumference).

If the roller 102 is worn unevenly, which can mean, for example, that the running surface is worn to different degrees along the circumference of the roller 102, the roller 102 can be guided past the sensor apparatus 104 multiple times and in this way a plurality of distance values between the measuring element 103 and the sensor apparatus 104 can be determined for various surface points of the roller 102 distributed along the circumference of the roller. In this way, wear can be determined at various measuring points along the circumference of the roller 102.

For example, it can be provided that for determining the distance value the roller 102 is guided past the sensor apparatus 104 N > 1 times, and each time the roller 102 passes the sensor apparatus 104 a distance value between the measuring element 103 and the sensor apparatus 104 is determined, and after N passages of the roller 102 past the sensor apparatus 104 a minimum distance value of the N distance values is determined and, on the basis of the minimum distance value, the wear state is determined. N can be a natural number greater than zero.

Even in the case of uneven wear along the circumference of the running surface of the roller 102, a precise determination of the wear state can thus be achieved. The larger the value N is selected, the more precisely the wear state of the roller can be determined. For example, it can be provided that the roller is guided past the sensor apparatus 104 N = 50 times. However, this value is to be understood by way of example; for example, it can also be provided that the roller is guided past the sensor apparatus 10425 times, 75 times, 100 times or any other arbitrary number of times in order to determine the minimum distance.

To achieve a continuous determination of the wear state over longer time intervals, such as several hours, several days or several weeks or any other time interval, it can also be provided that the minimum distance value after N passages of the roller 102 past the sensor apparatus 104 is determined smoothly, and after (N+i) passages of the roller 102 past the sensor apparatus 104, the minimum distance value of the distance values of the last N passages is determined and, on the basis of the minimum distance value of the last N passages, the wear state is determined. A precise determination of the wear state can thus be achieved even over longer time intervals. i can be a natural number greater than zero.

The determination of the minimum distance value just described can be carried out by the control unit 106 described above.

For example, it can also be provided that the wear state is determined on the basis of a change in the minimum distance value over time. By determining the change in the minimum distance value over time, for example, an average change in the wear value can also be determined, which in turn can allow the wear state to be extrapolated. On the basis of the extrapolation, for example, a point in time in the future can be determined at which the roller 102 will have a certain wear state and a pending replacement of the roller can be coordinated.

In the case of normal wear of the roller, the wear state of the roller will continuously deteriorate over time and the running surface will be worn down relatively uniformly along the circumference of the roller. However, if, for example, there is a material defect on the roller 102 or if an unusual force is applied to the roller 102, it may also happen that part of the running surface of the roller 102 breaks out or is knocked out. Such a defect may manifest itself by there being an unusually large difference between two successively determined distance values between the measuring element 103 and the sensor apparatus 104. To determine that there is a defect in the roller 102, it can be provided that the difference between two successively determined distance values between the measuring element 103 and the sensor apparatus 104 is determined and that this is compared with a threshold value. If the difference is greater than the threshold value, then it can be determined that there is a defect in the roller. If the difference is less than or equal to the threshold value, then it can be determined that there is no defect in the roller. In this case, the deviation can be attributed, for example, to uneven wear of the roller, in which case the roller does not need to be replaced immediately.

For this purpose, a series of threshold values can be stored in the memory unit of the control unit 106 described above. For example, a particular threshold value can be associated with a particular type of roller 102. The control unit 106 can be provided, on the one hand, to determine the difference between the two successively recorded distance values and to compare the difference with the threshold value.

If it is determined that there is a defect in the roller, it can be provided that information is output to a user indicating that the roller 102 is defective and that the roller 102 needs to be replaced. Alternatively, it can also be provided that an automated change of the roller 102 is initiated, for example by an automated changing device.

FIG. 2 shows the cam controller 100 already described in connection with FIG. 1 in a side view 100a according to a further embodiment. The embodiment in FIG. 2 can be combined with the embodiment in FIG. 1.

As already described in connection with FIG. 1, the roller 102 can be guided on a profile 101a of the cam controller 101, which, as described in connection with FIG. 1, can be arranged to be vertically aligned along the circumference next to a disk-like base plate 101b of the cam controller 101. This embodiment of the cam controller 101 is to be understood by way of example. With regard to alternative embodiments, reference is made to the explanations given in connection with FIG. 1.

The sensor apparatus 104 can be fastened to an underside of the base plate 101b of the control cam 101 via a holding apparatus 107. By means of the holding apparatus 107, the sensor apparatus 104 can be aligned such that, as already described in connection with FIG. 1, a measuring direction 109 of the sensor apparatus 104 is perpendicular to an axis of rotation 110 of the measuring element 103.

In the embodiment in FIG. 2, the measuring element 103 is fastened to the roller 102 such that a longitudinal axis of the measuring element 103 coincides with an axis of rotation of the roller 102. In the embodiment shown here, the measuring element 103 is designed as a hollow cylinder, which can be fastened to the roller 102 by means of a cheesehead screw 108. This specific embodiment of the measuring element is also to be understood by way of example.

On one side of the roller 102 opposite the side on which the measuring element 103 is arranged, the roller 102 can be connected via a guide device 105 to a treatment unit or a component of a treatment unit of a container treatment machine. By guiding the roller 102 along the profile 101a of the control cam 101, control of the component of the treatment unit or of the treatment unit can thus be achieved, as described in detail in FIG. 1.

What is claimed is:

1. A method for determining a wear state of a roller of a cam controller for a container treatment machine, the cam controller including a control cam, at least one roller movably guided along the control cam, and a measuring element carried along with the roller along the control cam, the control cam including a sensor apparatus, the method comprising:
determining a distance value between the measuring element and the sensor apparatus using the sensor apparatus as the roller is guided past the sensor apparatus as it runs along the control cam; and
determining a wear state of the roller on the basis of the distance value.

2. The method according to claim 1, wherein the roller for determining the distance value is guided past the sensor apparatus N > 1 times, and each time the roller passes the sensor apparatus, said determining a distance value is performed;
said determining the distance value comprises determining a minimum distance value of the N distance values after N passages of the roller past the sensor apparatus; and
said determining the wear state of the roller comprises determining the wear state of the roller on the basis of the minimum distance value.

3. The method according to claim 2, wherein the minimum distance value after N passages of the roller past the sensor apparatus is determined smoothly, after (N+i) passages of the roller past the sensor apparatus, the minimum distance value of the distance values of the last N passages is determined; and
said determining the wear state of the roller comprises determining the wear state of the roller on the basis of the minimum distance value of the last N passages.

4. The method according to claim 2, wherein said determining the wear state of the roller comprises determining the wear state of the roller on the basis of a change in the minimum distance value over time.

5. The method according to claim 4, wherein, if a difference between two successively determined distance values between the measuring element and the sensor apparatus is greater than a threshold value, it is determined that there is a defect in the roller.

6. The method according to claim 1, wherein the measuring element has an essentially cylindrical shape, and a longitudinal axis of the measuring element is aligned parallel to a rotation axis of the roller or wherein a longitudinal axis of the measuring element coincides with a rotation axis of the roller.

7. The method according to claim 1, wherein the sensor apparatus comprises an optical sensor unit, an acoustic sensor unit, or an inductive sensor unit, wherein if the sensor apparatus comprises the inductive sensor unit, the measuring element will comprise a metal.

8. The method according to claim 7, wherein the optical sensor unit comprises a laser.

9. The method according to claim 7, wherein the acoustic sensor unit comprises an ultrasonic sensor.

10. A cam controller for a container treatment machine, comprising:
a control cam;
at least one roller movably guided along the control cam;
a measuring element carried along with the roller along the control cam; and
a control unit;
wherein
the control cam comprises a sensor apparatus,
the roller is guided past the sensor apparatus as it runs along the control cam, and a distance value between the measuring element and the sensor apparatus can be determined using the sensor apparatus as the roller is guided past, and
the control unit is designed to determine a wear state of the roller on the basis of the distance value.

11. The cam controller according to claim 10, wherein
the roller for determining the distance value can be guided past the sensor apparatus N > 1 times,
each time the roller passes the sensor apparatus a distance value between the measuring element and the sensor apparatus is determined,
the control unit is designed to determine a minimum distance value of the N distance values after N passages of the roller past the sensor apparatus, and
the control unit is designed to determine the wear state on the basis of the minimum distance value.

12. The cam controller according to claim 10, wherein
the control unit is designed to determine the minimum distance value after N passages of the roller past the sensor apparatus,
after (N+i) passages of the roller past the sensor apparatus, the minimum distance value of the distance values of the last N passages is determined, and
the control unit is designed to determine the wear state on the basis of the minimum distance value of the last N passages.

13. The cam controller according to claim 11, wherein the control unit is designed to determine the wear state on the basis of a change in the minimum distance value over time.

14. The cam controller according to claim 13, wherein the control unit is designed to determine that a defect in the roller is present when a difference between two successively determined distance values between the measuring element and the sensor apparatus is greater than a threshold value.

15. The cam controller according to claim 10, wherein the measuring element has an essentially cylindrical shape, and a longitudinal axis of the measuring element is aligned parallel to a rotation axis of the roller or wherein a longitudinal axis of the measuring element coincides with a rotation axis of the roller.

16. The cam controller according to claim 10, wherein the sensor apparatus comprises an optical sensor unit, for example a laser, an acoustic sensor unit, for example an ultrasonic sensor, or an inductive sensor unit, wherein if the sensor apparatus comprises the inductive sensor unit, the measuring element will comprise a metal.

17. The cam controller according to claim 10, wherein the sensor apparatus is fastened to the control cam by means of a holding apparatus, wherein a measuring direction along which the distance value between the sensor apparatus and the measuring element can be determined is perpendicular to an axis of rotation of the measuring element.
